(19) United States
(12) Patent Application Publication
(10) Pub. No.: US 2005/0246051 A1
(43) Pub. Date: Nov. 3, 2005

(54) Method for controlling semiconductor process

(76) Inventor: Jong-Jun Kim, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/087,806

(22) Filed: Mar. 24, 2005

(30) Foreign Application Priority Data
Apr. 30, 2004 (KR) 2004-0030342

(51) Int. Cl. G06F 19/00

(52) U.S. Cl. 700/121; 700/108

(57) ABSTRACT

The present invention discloses a method of controlling a semiconductor manufacturing process system comprising a primary platform in communication with a secondary platform by transmitting recipe content from the primary platform to the secondary platform, performing a process on a wafer by the secondary platform based on the transmitted recipe content, and transmitting data generated after the process by the secondary platform to the primary platform.

### BACKGROUND OF THE INVENTION

1. Field of the Invention

The present invention generally relates to a method of manufacturing semiconductor devices. More particularly, the present invention generally relates to a method for controlling a semiconductor manufacturing process system.

A claim of priority is made to Korean Patent Application 2004-30342, filed on Apr. 30, 2004, the contents of which are incorporated by reference in their entirety.

2. Description of the Related Art

In general a semiconductor device is manufactured through a series of process steps. In a conventional semiconductor fabrication line, equipments to perform respective process steps, e.g., etching apparatuses, are disposed therein.

A conventional semiconductor manufacturing process control system comprises of several process apparatuses. In particular, etching apparatuses are generally used more frequently than other process apparatuses in the fabrication process.

FIG. 1 is a block diagram illustrating a conventional semiconductor manufacturing process control system network.

Referring to FIG. 1, a conventional semiconductor manufacturing process control system comprises a computer 10 and a plurality of process apparatuses 12.

At the beginning of a process, computer 10 transmits information containing wafer lot numbers and recipe names to the plurality of apparatuses 12.

The plurality of apparatuses 12 perform necessary processes corresponding to the received information. The plurality apparatuses 12 also transfer process data generated after a process to computer 10.

FIG. 2 is a flow chart illustrating a control process of the system network of FIG. 1.

As shown in FIG. 2, in step 14, recipe contents (process conditions necessary to process a wafer) for a wafer process are stored or set up in the plurality of apparatuses 12 by a user.

In step 16, a computer 10 transmits lot numbers and recipe names to the plurality of apparatuses 12.

In step 17, the plurality of apparatuses 12 check as to whether the transmitted recipe names coincide with their stored or set-up recipes.

In step 18, if the transmitted recipe name coincides with their stored recipe or set-up recipe, a process begins consistent with the recipe in the plurality of apparatuses 12.

In step 20, each apparatus 12 transmits data generated during the process to computer 10.

However, the conventional semiconductor manufacturing process control system has the following disadvantages.

If each apparatus requires a recipe set-up, valuable time is wasted, and wafer process defects frequently occur. In particular, in an etching apparatus, wafer etching defects, increase in particles, and break defects are caused by human input error.

The wafer etching defects occur because of improper RF power, pressure, and gas setting values.

A pressure value input error causes an increase in particles when particles fall off the inside of chambers when there is a difference in the pressure and power between a pressure value and chambers.

A recipe value input error may cause wafers to break or slide off during chucking and de-chucking.

These errors occur when inputs are manually inputted in each apparatus by a user, or stored in a diskette. Also input errors occur when users have to input changes in process conditions.

Also valuable time is wasted searching for the apparatus with the input error. Furthermore, recipe set-up defect can only be remedy after the occurrence of the defect.

Further, only limited amount of recipe data can be stored in the apparatuses due to storage capability of each of the apparatus.

### SUMMARY OF THE INVENTION

Accordingly, it is desirable to provide a semiconductor manufacturing process control method capable of reducing a recipe set-up time and an input.

According to one aspect of the present invention, a method of controlling a semiconductor manufacturing process system comprising a primary platform in communication with a secondary platform by transmitting recipe content from the primary platform to the secondary platform, by operation of the secondary platform, performing a process on a wafer based on the transmitted recipe content, and transmitting generated data related to the process from the secondary platform to the primary platform.

The present invention also discloses a method of controlling a semiconductor manufacturing process system comprising a computer in communication with a process apparatus by transmitting recipe content from the computer to the process apparatus, by operation of the process apparatus, performing a process on a wafer based on the transmitted recipe content, and transmitting generated data after the process from the process apparatus to the computer.

### BRIEF DESCRIPTION OF THE DRAWINGS

The present invention will become better understood from the detailed description given hereinbelow and the accompanying drawings which are given by way of illustration only, and wherein:

FIG. 1 is a block diagram illustrating a network of a general semiconductor manufacturing process control system;

FIG. 2 is a flow chart illustrating a conventional semiconductor manufacturing process control network; and

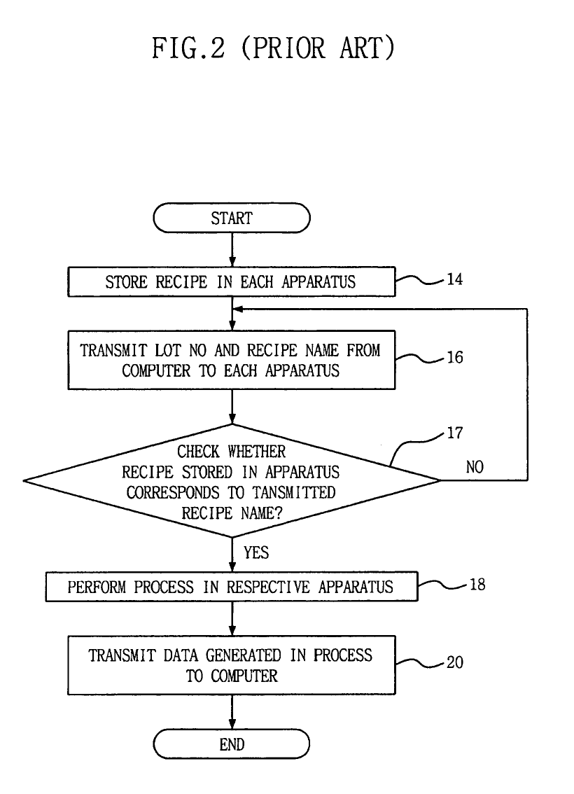

FIG. 3 is a flow chart illustrating a control method for a semiconductor manufacturing process system according to an embodiment of the invention.

### DETAILED DESCRIPTION OF THE INVENTION

Hereinafter, embodiments of the present invention will be described in detail. It will be understood by those skilled in the art that the present invention can be embodied in numerous different ways.

In the present invention, a semiconductor manufacturing process control system comprises a primary platform in communication with a secondary platform. The primary platform is preferably a computer 12, and in one embodiment, the secondary platform comprises a plurality of apparatuses 12. The plurality of apparatuses 12 is capable of performing a variety of semiconductor fabrication processes such as etching. Therefore, the plurality of apparatuses 12 is preferably an etching apparatus. Further, computer 10 is in communication with the plurality of apparatuses 12 by known a medium, such as on-line.

In the present invention, a process control system is configured to transmit not only recipe name but also recipe content from computer 10 to the plurality of apparatuses 12. Therefore, there is no need to set up or store recipe in the plurality of apparatuses 12.

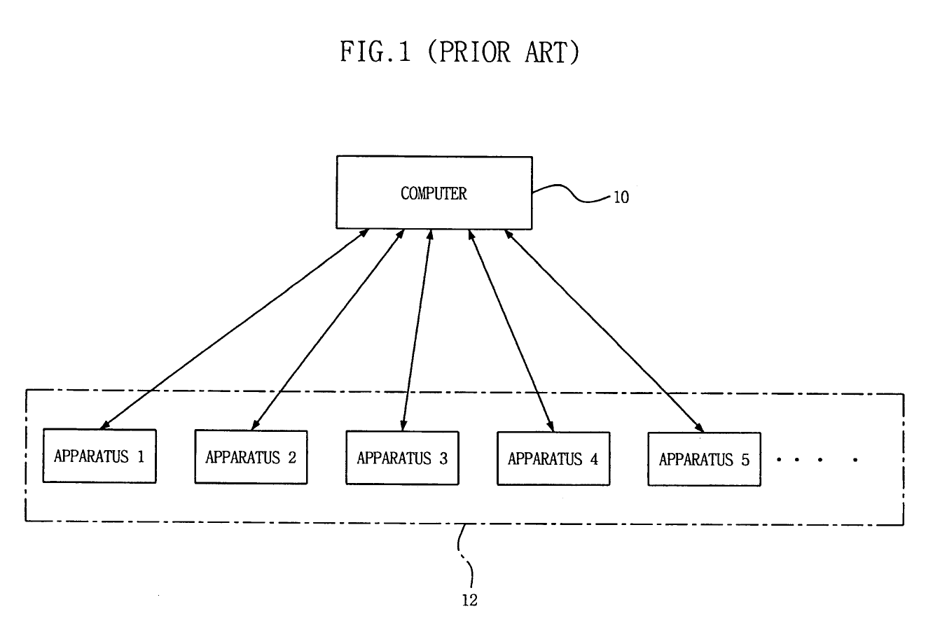

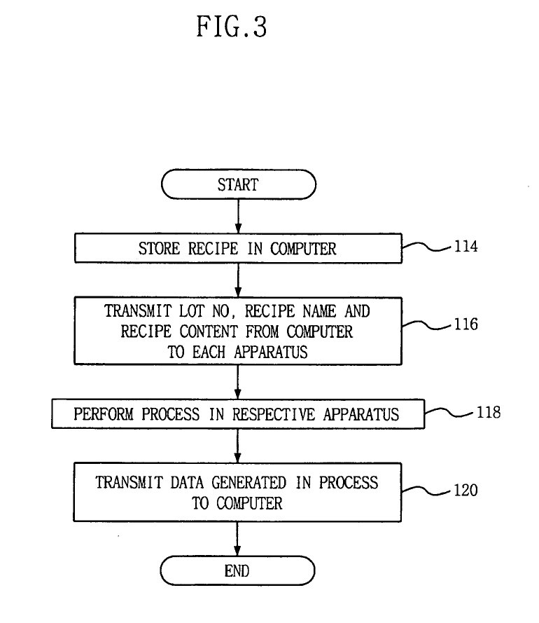

Referring to FIGS. 1 and 3, a semiconductor manufacturing process control system and a method will be described.

In FIGS. 1 and 3, recipe name and recipe content are stored in computer 10 in step 114. In this respect, computer 12 is equipped with an appropriate storage medium to store recipe data and corresponding programs.

In step 116, computer 10 transmits recipe name, recipe content, wafer lot number the plurality of apparatuses 12. Hence, a user recipe input error is prevented in advance.

In step 118, the plurality of apparatuses 12 perform process corresponding to respective recipe for the wafers corresponding to transmitted lot numbers. Each individual apparatus has a hardware and/or software capable of executing information received from computer 10.

In the prior art, each process apparatus required individual set up recipes, but according to an exemplary embodiment of the present invention, computer 10 transmits the same recipes to all the plurality of apparatuses 12, thereby identical processes are performed by each individual apparatus.

In step 120, data generated in the plurality of apparatuses 12 is transmitted to computer 10, this ensures whether a process is executed corresponding to the lot number and recipe content transmitted in step 116 from computer 10.

In the plurality of apparatuses 12, a storage device is not required to store recipe, therefore different data can be stored, improving data storage capability.

As described above, according to an exemplary embodiment of the invention, recipes are set up only in a computer, instead of setting up the recipe in individual apparatus, thereby reducing recipe set-up time and increasing process efficiency. Further, input errors caused by individually setting-up recipes in respective apparatuses can be substantially reduced.

In addition, improved data storage capability of the process apparatus can be achieved.

It will be apparent to those skilled in the art that modifications and variations can be made to the present invention without deviating from the scope of the present invention.

1. A method of controlling a semiconductor manufacturing process system comprising a primary platform in communication with a secondary platform, the method comprising:
transmitting recipe content from the primary platform to the secondary platform;
by operation of the secondary platform, performing a process on a wafer based on the transmitted recipe content; and
transmitting generated data related to the process from the secondary platform to the primary platform.

2. The method of claim 1, wherein the primary platform is a computer.

3. The method of claim 1, wherein the secondary platform is a plurality of semiconductor manufacturing apparatuses.

4. The method of claim 3, wherein the plurality of semiconductor manufacturing apparatuses comprises an etching apparatus.

5. The method of claim 1, further comprising transmitting a lot number and recipe name from the primary platform to the secondary platform.

6. A method of controlling a semiconductor manufacturing process system comprising a computer in communication with a process apparatus, the method comprising:
transmitting recipe content from the computer to the process apparatus;
by operation of the process apparatus, performing a process on a wafer based on the transmitted recipe content; and
transmitting generated data related to the process from the process apparatus to the computer.

7. The method of claim 6, wherein the process apparatus comprises an etching apparatus.

8. The method of claim 7, further comprising transmitting a lot number and recipe name from the primary platform to the secondary platform.
